(19) United States
(12) Patent Application Publication
(10) Pub. No.: US 2002/0006322 A1
(43) Pub. Date: Jan. 17, 2002

(54) Pod door opener

(75) Inventors: Ilya Perlov, Sunnyvale, CA (US); Eugene Gantvarg, Santa Clara, CA (US); Howard E. Grunes, Santa Cruz, CA (US); Alexey Goder, Sunnyvale, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 09/882,130

(22) Filed: Jun. 14, 2001

Related U.S. Application Data
(63) Continuation-in-part of application No. 09/795,907, filed on Feb. 27, 2001.
(60) Provisional application No. 60/187,133, filed on Mar. 6, 2000.

(51) Int. Cl. B65G 49/07

(52) U.S. Cl. 414/217

(57) ABSTRACT

A pod opening station moves a wafer-carrying pod horizontally to engage a door of the pod with a pod door receiver. The pod door receiver removes and holds the pod door with no vertical movement thereof. The pod is then moved horizontally in a reverse direction a short distance away from the pod door receiver. Then the pod is moved vertically into alignment with an opening in an interface wall. A wafer handler blade is extended through the opening into the pod. The pod is indexed downwardly to transfer a wafer to the wafer handler blade. The wafer handler blade then retracts to remove the wafer from the pod.

This application is a continuation-in-part of U.S. patent application Ser. No. 09/795,907 filed Feb. 27, 2001, which claims priority from U.S. Provisional Application Serail No. 60/187,133 filed Mar. 6, 2000. Both of these applications (U.S. Ser. Nos. 09/795,907 and 60/187,133) are hereby incorporated by reference herein in their entirety.

### FIELD OF THE INVENTION

The present invention is concerned with semiconductor manufacturing, and is more particularly concerned with an automated method and apparatus adapted to open a sealed wafer-carrying pod and extract wafers therefrom.

### BACKGROUND OF THE INVENTION

Conventional semiconductor fabrication systems transport a plurality of wafers in a sealed container or pod, thereby maintaining the wafers in a clean/controlled environment. Thus, conventional processing systems include a plurality of pod opening stations where the sealed pods are opened, and wafers are extracted therefrom and loaded into the processing system. Each pod opening station comprises a pod platform adapted to receive a sealed pod, and a pod door receiver adapted to engage and unlatch a door portion of the pod.

In operation to open a front opening unified pod (a FOUP), the pod platform receives the pod and moves the pod horizontally toward the pod door receiver. The pod door receiver engages and unlatches the pod door, and moves the pod door horizontally away from the pod platform. The pod door receiver then moves vertically downward to provide clear access to wafers contained in the pod.

Thereafter, to extract a wafer from the pod, a wafer handler moves vertically to an elevation just below a first wafer contained within the pod, extends, elevates to lift the first wafer off of a supporting mechanism, and retracts carrying the wafer therewith. After placing the wafer within a processing system, the wafer handler elevates to a position just below a second wafer contained within the pod, extends, elevates and retracts carrying the second wafer into the processing system. This sequence repeats for each wafer contained within the pod.

The wafer handler thus requires a wide vertical opening (e.g., in a clean room wall that separates the wafer handler from the pod) through which wafers may be extracted. The wide opening increases the probability that contaminants may enter the processing system's clean environment. Further, the multi axis movements required of both the wafer handler and the pod door receiver increase equipment expense and reduce equipment reliability.

Accordingly, there is a need for an improved pod loading station which requires fewer movements and/or reduces potential contaminants and thus addresses the ever-present demand for reduced cost per unit wafer processed.

### SUMMARY OF THE INVENTION

According to a first aspect of the invention, a method of interfacing a wafer carrying pod to a pod opening station includes moving the pod horizontally to engage a door of the pod with a pod door receiver of the pod opening station, and moving the pod vertically to align the pod with an opening of an interface wall of the pod opening station.

The method may further include moving the pod horizontally away from the pod door receiver after the door of the pod is engaged with the pod door receiver and before the step of moving the pod vertically.

A wafer handler blade may be extended into the pod after the pod is aligned with the opening in the interface wall and the pod may then be indexed downwardly to transfer a wafer from the pod to the wafer handler blade.

According to another aspect of the invention, a pod opening station adapted to open and unload a wafer-carrying pod includes an interface wall and a pod platform adjacent the interface wall and adapted to move the pod in a horizontal direction and in a vertical direction. The pod opening station further includes a pod door receiver in the interface wall adjacent the pod platform, the pod door receiver being adapted to remove a door from the pod and to hold the removed door in a fixed position.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a partial schematic top plan view of a conventional wafer processing system;

FIG. 2 is a schematic side view of a conventional pod opening station;

FIGS. 3A-3E are cross-sectional views of a pod opening station provided in accordance with the invention, showing sequential steps in a pod opening and wafer unloading operation;

FIGS. 4A and 4B are side schematic views of a cover plate for a pod-unloading opening shown in a closed position and an open position, respectively; and

FIG. 5 is a front schematic view of the cover plate of FIGS. 4A and 4B.

### DETAILED DESCRIPTION OF THE PREFERRED EMBODIMENTS

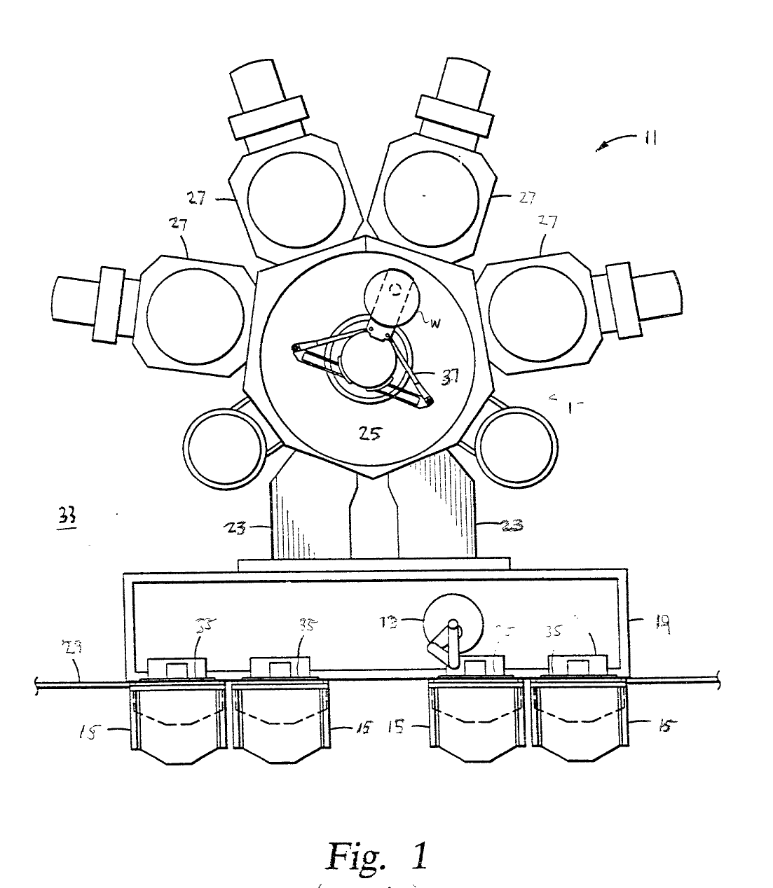

FIG. 1 is a schematic top plan view, in pertinent part, of a conventional processing system 11 having a factory interface wafer handler 13 for transporting wafers between a plurality of pod opening stations 15 and a processing tool 17. The exemplary processing system 11 shown in FIG. 1 includes an interface chamber 19 and the processing tool 17 which may comprise a pair of loadlock chambers 23, a transfer chamber 25 coupled to the loadlock chambers 23, and a plurality of processing chambers 27 coupled to the transfer chamber 25.

An interface wall 29 is positioned between the pod opening stations 15 and the processing system 11 for separating a “white area” clean room 31 from a less clean, “gray area” clean room 33. The pod opening stations 15 are located in the “white area” clean room 31 and the processing system 11 is located in the less clean, “gray area” clean room 33. The pod opening stations 15 are positioned adjacent sealable openings 35 in the interface wall 29. Each pod opening station 15 comprises a pod platform (not shown) adapted to receive a sealed pod and a pod door receiver (not shown) adapted to engage and unlatch a door portion of the sealed pod (not shown) as is known in the art.

The exemplary interface chamber 19 contains an interface wafer handler 13 mounted to a track T (not shown). The transfer chamber 25 of the processing tool 17 contains a transfer wafer handler 37 adapted to transport a wafer W between the loadlock chambers 23 and the processing chambers 27.

In operation, a pod containing a cassette of wafers, is loaded onto the pod opening station 15. A pod door receiver engages and unlatches the door portion of the pod and removes the door portion so as to allow access to the wafers contained in the pod. The interface wafer handler 13 of the interface chamber 19 then extracts a wafer from the pod and transports the wafer to one of the loadlock chambers 23. Thereafter, the transfer wafer handler 37 of the processing tool 17 transports the wafer from the loadlock chamber 23 to a processing chamber 27 wherein a processing step is performed on the wafer.

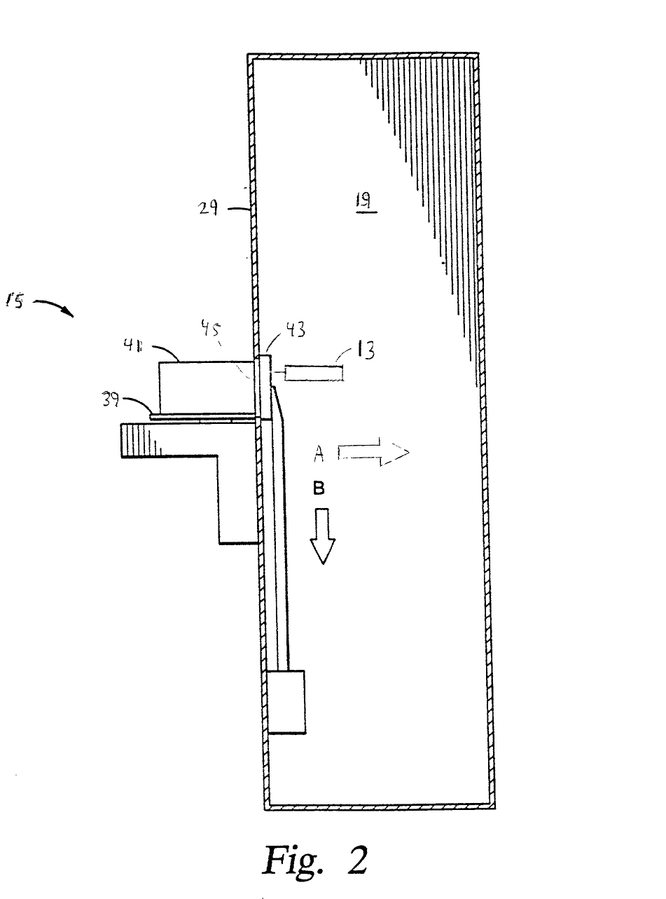

FIG. 2 is a schematic side view of a conventional pod opening station 15 which may be employed as the pod opening station 15 of FIG. 1. As previously stated, the pod opening station 15 comprises a pod platform 39 adapted to receive a pod 41 and a pod door receiver 43 adapted to engage and unlatch a door portion 45 of the pod 41 as is known in the art. In FIG. 2, the pod 41 is shown positioned on the pod platform 39.

In operation, the pod platform 39 moves along a horizontal plane to receive the pod 41 in a position away from the interface wall 29. The pod platform 39 then moves the pod 41 into a position adjacent the interface wall 29, wherein the door portion 45 of the pod 41 engages the pod door receiver 43. The pod door receiver 43 engages and unlatches the door portion 45 of the pod 41. The pod door receiver 43 moves the pod door portion 45 horizontally away from the pod platform 39 as indicated by arrow A and then moves the pod door 45 vertically downward as indicated by arrow B, until the opening in the interface wall 29 is cleared.

Thereafter, to extract a wafer from the pod 41, the interface wafer handler 13 contained within the processing system 11 moves vertically to an elevation just below a first wafer contained within the pod 41, then extends to a position beneath the first wafer, elevates to lift the first wafer off of the supporting mechanism (which typically supports the wafers contained within the pod 41 by their edges), and retracts carrying the wafer into the processing system 11. After placing the wafer within the processing system 11, the interface wafer handler 13 elevates to a position just below a second wafer contained within the pod 41 and then extends, elevates and retracts carrying the second wafer into the processing system 11. This sequence is repeated for each wafer contained within the pod 41.

The interface wafer handler 13 thus requires a wide vertical opening through which to extract each vertically stacked wafer contained within the pod. The wide opening increases the probability that contaminants may enter the processing system's 11 clean environment. Further, the multi axis movement required of both the interface wafer handler 13 and the pod door receiver 43 increases equipment expense and reduces equipment reliability.

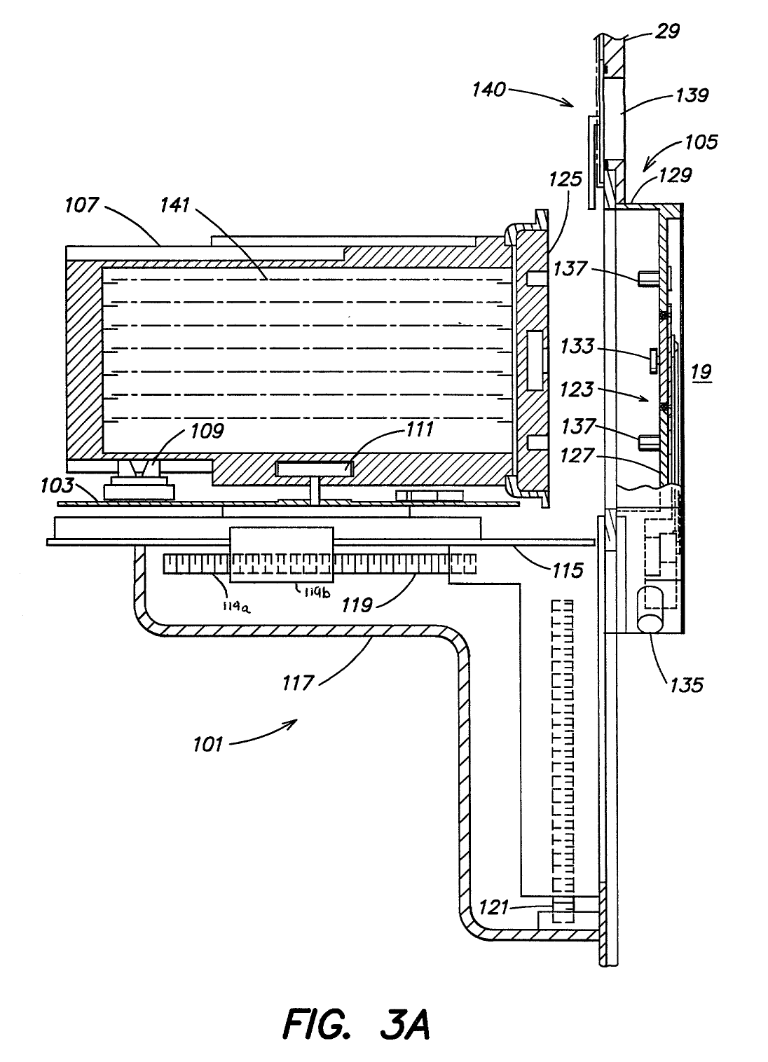

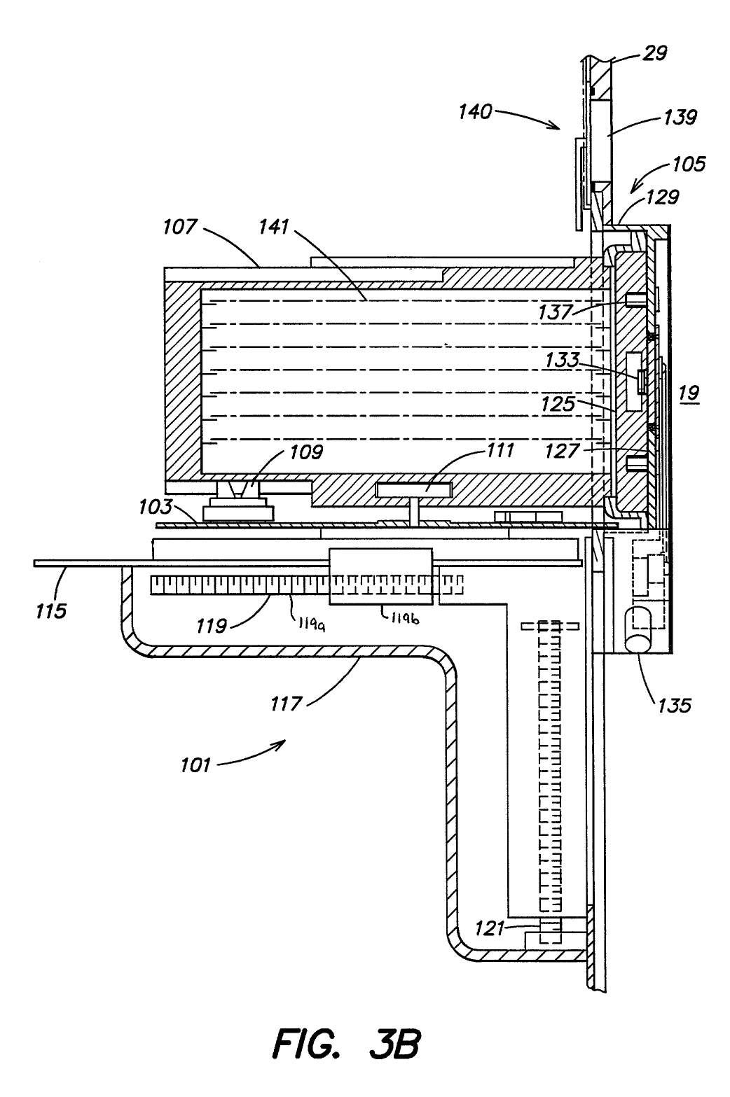

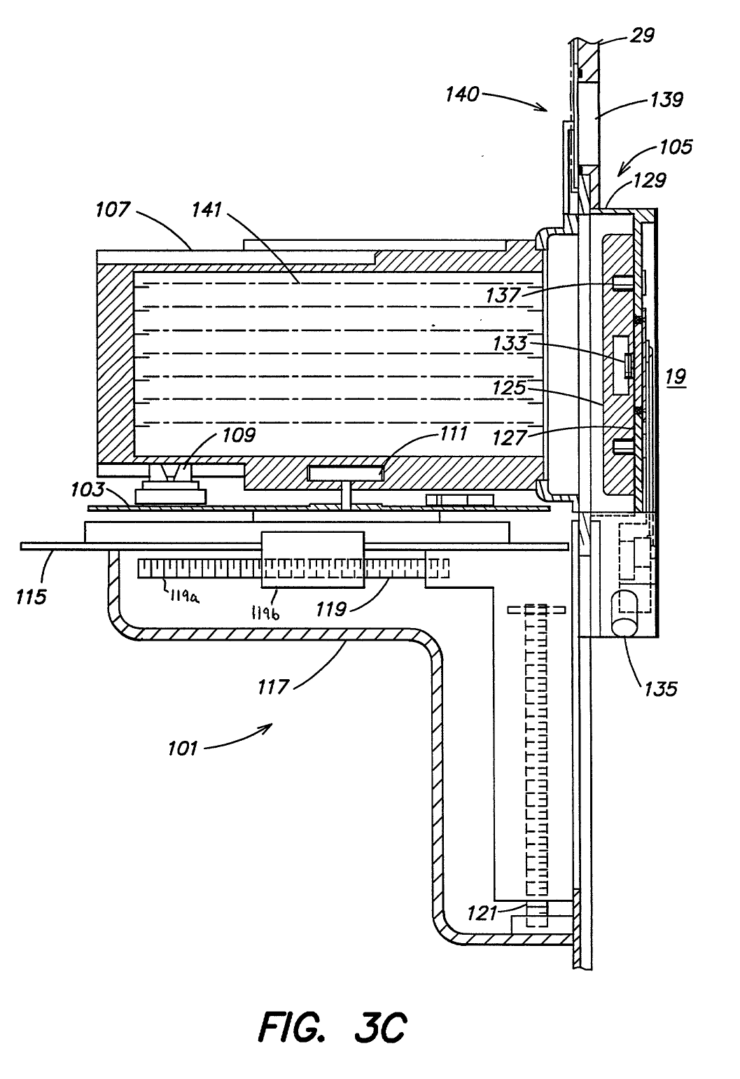

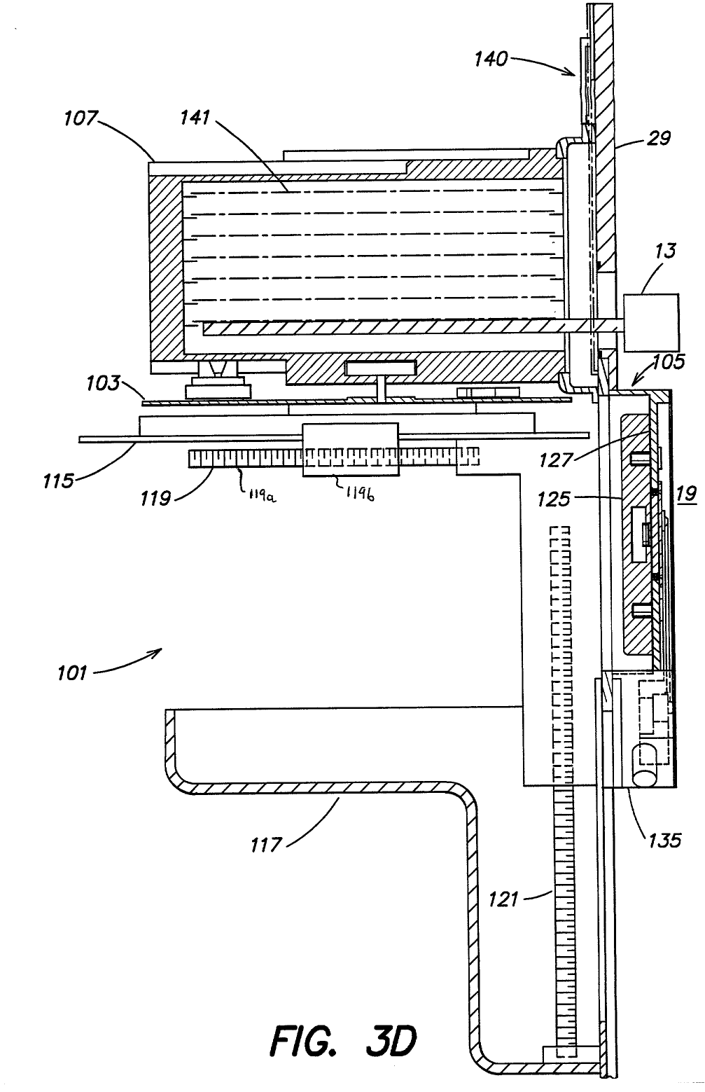

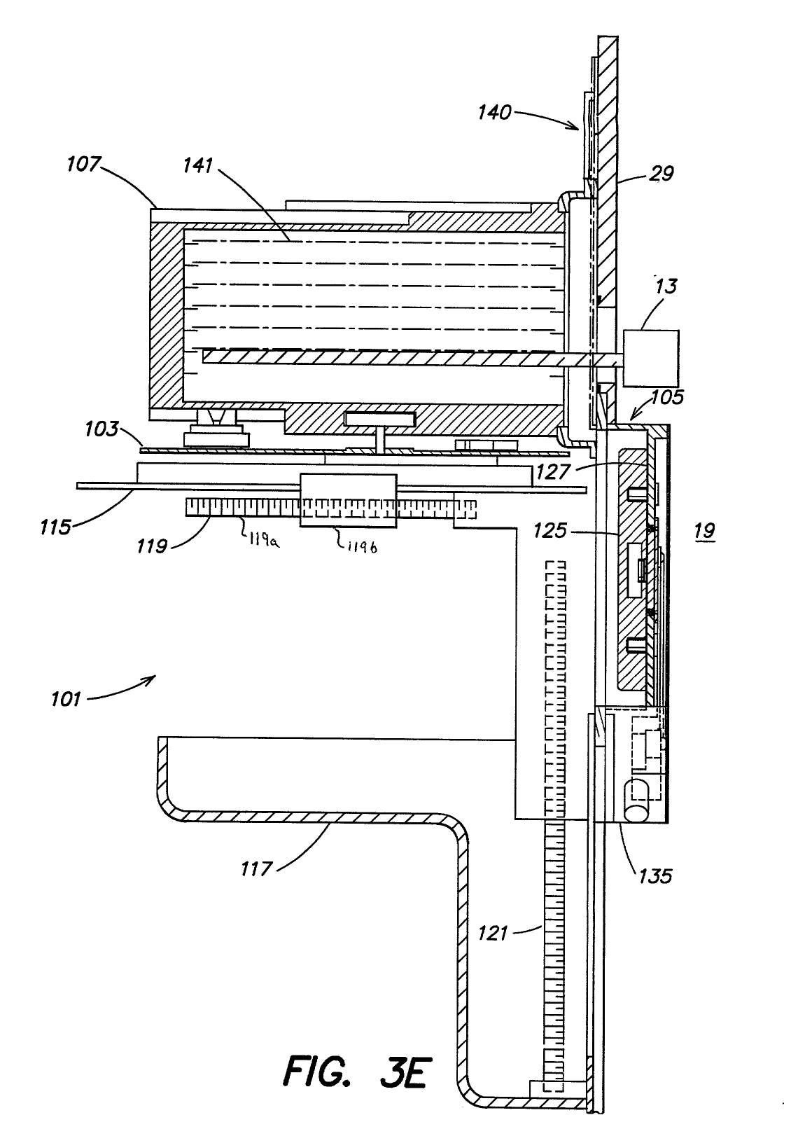

Accordingly, the present inventors have provided an improved pod opening station which requires fewer movements and/or may reduce potential contaminants, as described below with reference to FIGS. 3A-E.

FIGS. 3A-E are cross-sectional views of an inventive pod opening station 101. The inventive pod opening station 101 comprises a pod platform 103 and a pod door receiver 105. A pod 107 is shown positioned on alignment pins 109 which are connected to the pod platform 103. A locking mechanism 111 coupled to the pod platform 103 secures the aligned pod 107 in place on the pod platform 103. The pod platform 103 is translatably mounted (via a horizontal actuator 119) to a base plate 115 which supports the pod platform 103. An enclosure wall 117 encloses the horizontal actuator 119 and a vertical actuator 121 which is positioned below the base plate 115 and coupled thereto so as to selectively raise and lower the base plate 115. In the exemplary embodiment shown in FIGS. 3A-E, the horizontal actuator 119 comprises a lead screw 119a having a fitting 119b movably mounted thereto. The base plate 115 fixedly mounts to the fitting 119b and translates therewith along the lead screw 119a.

The pod door receiver 105 may define a recess 123 into which a pod door 125 may be received. The recess 123 is defined by a plate 127 and walls 129. The plate 127 of the recess 123 includes a pod door key actuating mechanism which comprises a key 133 and a pneumatic actuator 135 coupled to the key 133 and adapted to rotate the key 133 so as to unlatch the pod door 125 from the remainder of the pod 107, Alignment pins 137 are also provided on the plate 127 for aligning the pod door 125 with the pod door receiver 105 such that the pod door receiver key 133 enters a corresponding key hole (not shown) on the pod door 125.

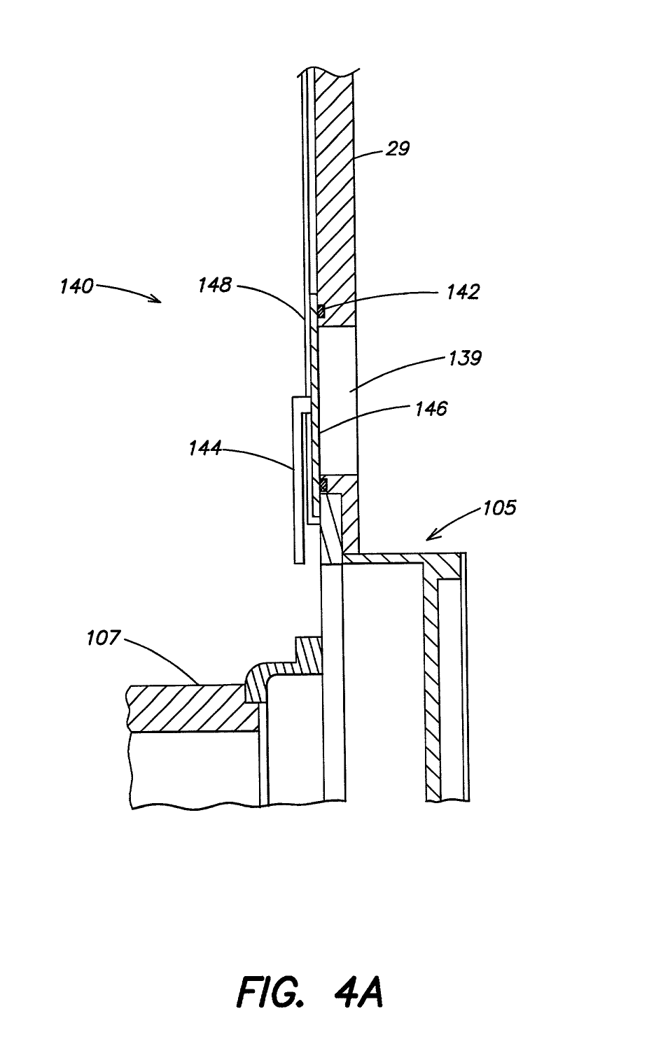

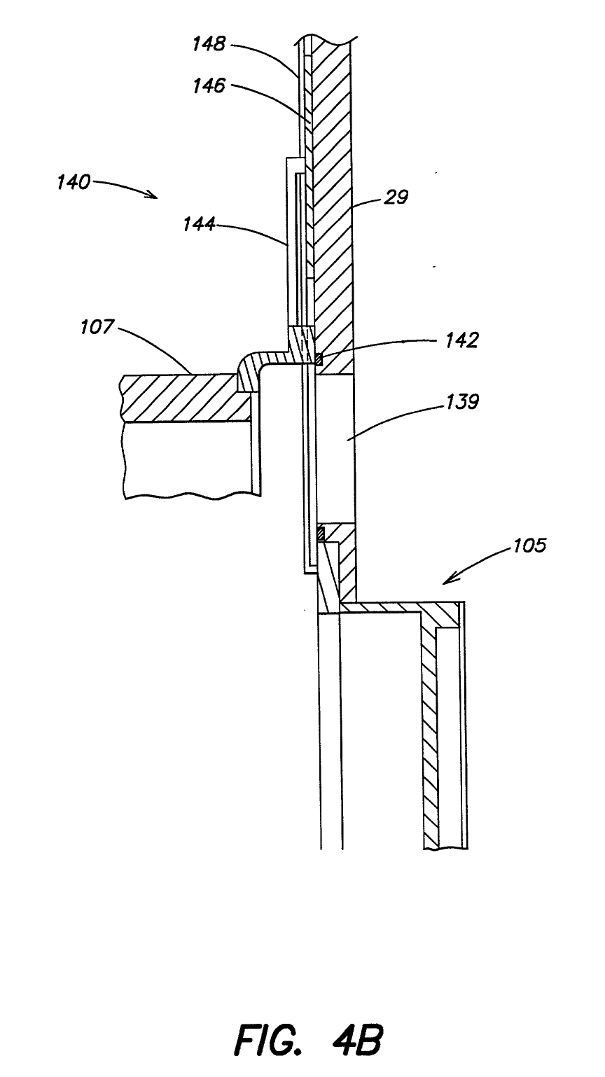

An opening 139 in the interface wall 29 is positioned directly above the pod door receiver 105. A higher pressure may be maintained in the interface chamber 19 than that maintained in the white area clean room 31, thus deterring air from entering the interface chamber 19 via the opening 139. In this manner, contaminants may be deterred from migrating into the interface chamber 19. The interface wafer handler 13 is horizontally aligned with the opening 139 and is adapted to extract wafers 141 (shown in phantom) from the pod 107 and to transport the wafers 141 to the processing system 11 as described below. Alternatively or additionally, an optional cover plate 146 (FIGS. 4A-B and 5) may be designed to occlude and/or seal the opening 139 when the pod 107 is either absent or in an initial, lowered position.

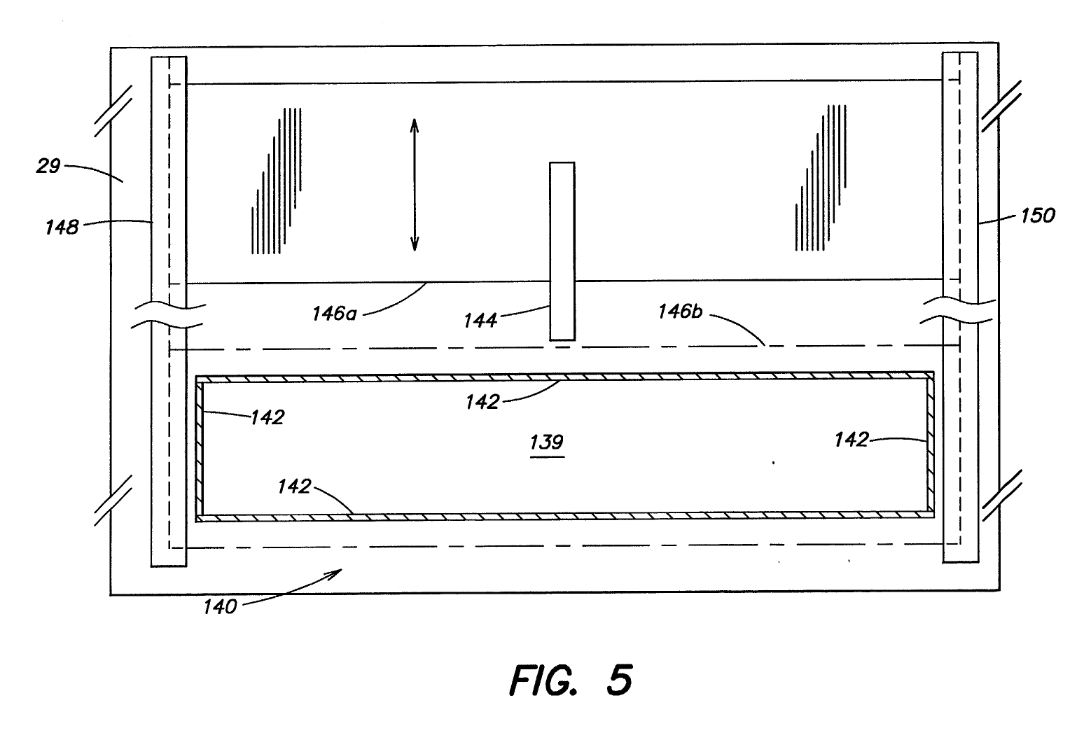

FIGS. 4A and 4B are side schematic views showing the cover plate 146 in a closed position and an open position, respectively, and FIG. 5 is a front schematic view of the cover plate 146. The cover plate 146 may comprise an o-ring 142 having a perimeter larger than the perimeter of the opening 139. Alternatively the o-ring 142 may be mounted to the interface wall 29 (e.g., in a groove, etc.) as shown. The o-ring 142 is adapted to seal between the outer surface of the interface wall 29 and the cover plate 146, to thereby seal the opening 139. Attached to the outer surface of the interface wall 29 (in a position so as not to occlude the opening 139) may be a guide mechanism 148 (such as a pair of guide rails). The guide mechanism 148 may be attached to and extend horizontally outward a distance from the outer surface of the interface wall 29. In this manner the guide mechanism 148 provides a ledge on which the cover plate 146 may rest. The guide mechanism 148 may extend upwardly a distance equal to the maximum upward stroke of the cover plate 146, as described further below. An extension 144 extends from the outer surface of the cover plate 146 downwardly toward the pod platform 103. The extension 144 terminates at a position so as to be slightly above the top surface of a pod positioned on the pod platform 103. In this manner pod 107 may be placed on the pod platform 103 and may move horizontally forward toward the interface to a position wherein the pod 107 is under the extension 144. Thus when the pod 107 elevates it will contact the extension 144 and thereby open the cover plate 146 as further described below with reference to FIGS. 3A-5.

The operation of the inventive pod opening station 101 is described with reference to the sequential views of FIGS. 3A-E, which show the movement of the pod 107, and with reference to FIGS. 4A-5 which are close up views of the cover plate 146. FIG. 3A shows the pod 107 aligned on the alignment pins 109 of the pod platform 103 which ensure proper positioning of the pod 107 relative to the pod door receiver 105. The locking mechanism 111 secures the pod 107 to the pod platform 103. The horizontal actuator 119 then moves the pod platform 103 horizontally toward the recess 123 of the pod door receiver 105, wherein the pod door 125 engages the pod door receiver 105, as shown in FIG. 3B.

The alignment pins 137 on the pod door receiver 105 ensure proper alignment of the pod door 125 such that the key 133 positioned on the pod door receiver 105 engages a lock (not shown) on the pod door 125. The pneumatic actuator 135 rotates the key 133 to unlock the pod door lock (not shown). Once the pod door is unlocked from the remainder of the pod 107, the pod platform 103 may move horizontally slightly away from the pod door receiver 105 to a position sufficient for the pod 107 to clear the interface wall 29 as shown in FIG. 3C.

The vertical actuator 121 moves the base plate 115 and the pod 107 positioned thereon upward, to a position adjacent the opening 139 such that a first wafer contained within the pod 107 is just above the elevation of interface wafer handler 13 as shown in FIG. 3D. As the pod 107 is raised from the position shown in FIG. 3C to the position shown in FIG. 3D, the pod 107 contacts the extension 144 of the cover plate 146 (FIG. 4A). Consequently, the pod 107 raises the cover plate from the position shown in FIG. 4A (shown in phantom in FIG. 5) to the position shown in FIG. 4B (shown in solid lines in FIG. 5), thereby uncovering the opening 139. Thereafter, to extract the first wafer from the pod 107, the blade of the interface wafer handler 13 moves horizontally and extends to a position beneath the first wafer. The base plate 115 having the pod 107 positioned thereon then indexes downward via the vertical actuator 121 such that the blade may lift the first wafer off of the support provided within the pod 107. The blade of the interface wafer handler 13 retracts and carries the first wafer out of the pod 107 and into the processing system 11. The base plate 115 having the pod 107 positioned thereon then indexes downward such that a second wafer contained within the pod 107 is just above the elevation of the interface wafer handler 13, as shown in FIG. 3E. The blade of the wafer handler 13 extends to a position beneath the second wafer, the base plate 115 then lowers, the wafer handler retracts and the sequence described above repeats for each wafer contained within the pod.

Accordingly, the inventive pod opening station 101 may eliminate the vertical movement required of conventional interface wafer handlers 13 and the horizontal movement required of conventional pod door receivers 41 (FIG. 2). With the present invention, the interface wafer handler 13 may employ only horizontal movement, and the pod door receiver 105 may remain stationary. Therefore, the inventive pod opening station 101 may decrease equipment expense and increase equipment reliability.

Further, the size of the opening 139 in the interface wall 29 may be narrower, particularly as compared to the openings required by conventional pod opening systems. Such a narrow opening reduces the probability that contaminants may enter the processing system 11's clean environment.

The foregoing description discloses only the preferred embodiments of the invention, modifications of the above disclosed apparatus and method which fall within the scope of the invention will be readily apparent to those of ordinary skill in the art. For example, the design of the cover plate and the corresponding guide mechanism may vary. To avoid rubbing between the o-ring and cover plate, the system may be designed such that the pod moves horizontally forward toward the interface wall, has its pod door removed and elevates slightly to contact the cover plate extension. After contacting the extension the pod may move horizontally backward to carry the cover plate slightly away from the interface wall before the cover plate is elevated. Quick release detention pins may be employed to hold the cover plate against the opening.

The horizontal actuator 119, the vertical actuator 121, and the pneumatic actuator 135 may comprise a stepper motor, an electric motor, etc. Also, the specific shapes, sizes and interconnections between components are merely exemplary as is the processing system 11 of FIG. 1. The locking and alignment features are optional, and may vary from those described herein.

Furthermore, the wafer loading opening 139 may be positioned below the pod door receiver 105 instead of above the pod door receiver, so that the pod 107 is moved vertically downwardly instead of upwardly after the pod door 125 is removed.

Accordingly, while the present invention has been disclosed in connection with the preferred embodiments thereof, it should be understood that there may be other embodiments which fall within the spirit and scope of the invention, as defined by the following claims.

The invention claimed is:

1. A method of opening a wafer-carrying pod having a door, comprising:
moving the pod horizontally to engage a door of the pod with a pod door receiver of a pod opening station, and
thereafter moving the pod vertically to align the pod with an opening in an interface wall at the pod opening station.

2. The method of claim 1, wherein the pod is moved horizontally away from the pod door receiver after the door of the pod is engaged with the pod door receiver and before the step of moving the pod vertically.

3. The method of claim 2, further comprising extending a wafer handler blade into the pod after the pod is aligned with the opening in the interface wall.

4. The method of claim 3, further comprising indexing the pod downwardly, with wafer handler blade extended into the pod, to thereby transfer a wafer from the pod to the wafer handler blade.

5. The method of claim 4, further comprising retracting the wafer handler blade, after the pod is indexed downwardly, to carry the wafer out of the pod.

6. The method of claim 5, wherein the pod door is not moved at any time between engagement of the pod door with the pod door receiver and removal of the wafer from the pod.

7. The method of claim 1, wherein:
during the vertical movement of the pod, the pod contacts an extension of a cover plate adapted to cover the opening, and thereby raises the cover plate so as to uncover the opening.

8. A pod opening station adapted to open and unload a wafer-carrying pod, comprising:
an interface wall;
a pod platform adjacent the interface wall and adapted to move the pod in a horizontal direction and in a vertical direction; and
a pod door receiver in the interface wall adjacent the pod platform, the pod door receiver being adapted to remove a door from the pod and to hold the removed door in a fixed position.

9. The pod opening station of claim 8, further comprising an opening in the interface wall above the pod door receiver.

10. The pod opening station of claim 9, further comprising a wafer handler adjacent the opening and adapted to extend a blade through the opening and into the pod.

11. The pod opening station of claim 10, further comprising a cover plate adapted to selectively cover the opening, the cover plate having an extension adapted to be contacted by the pod so as to raise the cover plate and thereby uncover the opening.
